(19) United States
(12) Patent Application Publication
(10) Pub. No.: US 2017/0334785 A1
(43) Pub. Date: Nov. 23, 2017

(54) LOW-TEMPERATURE CO-FIRED MICROWAVE DIELECTRIC CERAMIC MATERIAL AND PREPARATION METHOD THEREOF

(71) Applicant: WALSIN TECHNOLOGY CORPORATION, Taipei City (TW)

(72) Inventors: Li-Wen Chu, Taipei City (TW); Kuei-Chih Feng, Taipei City (TW); Chih-Hao Liang, Taipei City (TW)

(73) Assignee: WALSIN TECHNOLOGY CORPORATION, Taipei City (TW)

(21) Appl. No.: 15/597,011

(22) Filed: May 16, 2017

(30) Foreign Application Priority Data
May 17, 2016 (TW) 105115195

(51) Int. Cl. C04B 35/22; C04B 35/20; C04B 35/64; C04B 35/626; C04B 35/63

(52) U.S. Cl. CPC C04B 35/22; C04B 35/6262; C04B 35/6316; C04B 35/64; C04B 35/20; C04B 2235/3445; C04B 2235/3236; C04B 2235/3208; C04B 2235/3454; C04B 2235/365; C04B 2235/656; C04B 2235/96; C04B 2235/3249

(57) ABSTRACT

A low-temperature, high stability co-fired microwave dielectric composite of ceramic and glass, including 85-99 wt % microwave dielectric ceramic of formula [1-y-z[(1−x)Mg₂SiO₄−xCa₂SiO₄]−yCaTiO₃−zCaZrO₃, wherein 0.2≦x≦0.7,0.05≦y≦0.3 and 0.02≦z≦0.15], and 1 to 15 wt % with Li₂O—BaO—SrO—CaO—B₂O₃—SiO₂ glass respectively made at a low sintering temperature of ceramic for co-firing with Ag or Cu electrode, employing eutectic phase of ceramic oxides to reduce its melting temperature, a low melting-point glass material with high chemical stability as a sintering aid added to oxides and raw material powders of Li₂O, BaO, SrO, CaO, B₂O₃ and SiO₂, obtained by combining and melting the ingredients in the temperature range between 1000 to 1300° C., quenching and crashing, and then adding it to the main ceramic oxides to form the final composition. This ceramic/glass composite material may be co-fired with an Ag and Cu electrode at 900° C.-970° C. for 0.5-4 hours in a protective atmosphere. After sintering, this dielectric material possesses efficacious microwave dielectric properties, dielectric constant between middle-K to low-K at 8⁻15, high quality factors, low dielectric loss, low temperature-capacitance coefficient and superior chemical stability suitable for manufacture of multilayer ceramic devices.

### BACKGROUND OF THE INVENTION

### 1. Field of the Invention

The present invention relates to a microwave dielectric material and its preparation method, and more particularly, to producing a microwave dielectric material prepared through the technique of low-temperature co-fired ceramic.

### 2. Description of the Prior Art

Current communication industry development requires multi-functionalities and miniaturization of the wireless communication devices. Modularization of the radio frequency (RF) circuit has become key to development in the industry. In such development, resistance-capacitance delay (RC delay) has become more intensive due to the shrinking distance between the transmission lines of microwave device, resulting in an increase of interference and power consumption when an electronic signal is transferring among metals. Moreover, the low-temperature, co-fired ceramic material and process technology thereof is widely used in applications of microwave devices and is a key technique that has become the focus of the industrial field in developing communications components such as, for example: filters, couplers, antennae etc. To solve the problem of RC delay and provide the properties of co-firing ceramics at low temperatures, the present invention discloses a material with low dielectric constant which can co-fire with low-melting-point metal electrodes, such as Ag or Cu, etc. at a low temperature. With the increasing demand for communication industry, the annual global market growth rate of the microwave ceramic material applied in the microwave ceramic capacitor has been about 15%.

Conventional materials of low dielectric constant include silicate (such as Sr2SiO4, Ba2SiO4, Mn2SiO4), molybdate (SrMoO4, BaMoO4, SrMoO4) and tungstate (BaWO4, MgWO4), which all have a low microwave dielectric constant and efficacious properties; however, the material of molybdate and tungstate are expensive. This silicate is most widely applied in this field due to its low dielectric constant and low material cost. Mg2SiO4 has a low dielectric constant and high quality factor of 240000 GHz; however, the temperature capacitance coefficient is relatively high up to −70 (ppm/° C.).

The prior art, CN 1315134, discloses a material system of Mg2SiO4-MgTiO3 that can reduce the temperature capacitance coefficient effectively; however, its sintering temperature is higher than 1300° C., making it impossible to be employed in the low-temperature co-fired process. Furthermore, literature in the prior art including CN 101429015A has reported that Ca2SiO4 has a high quality factor and low dielectric constant (8.6), but it belongs to a high-temperature sintering material (>1200° C.). The prior art also discloses a Mg2SiO4 having a low dielectric constant of 6 to 8, dielectric loss value less than 10-5 and the Qf value up to 160000 GHz. Such materials can be applied in electronic circuit substrate, filter, microwave substrate high frequency communication, but it has a high sintering temperature of 1300-1500° C. Consequently, this sintering temperature is still too high for it to be co-fired with Cu and Ag electrode.

The prior art also discloses a Li contained compound oxide ceramic Li2Ba3TiO20 having a dielectric constant of 28-28.7, a quality factor of 54000^{˜}79000 GHz, a temperature coefficient of about −7 ppm/° C. This compound has a sintering temperature ranging from 1000 to 1040° C., which is though lower than 300° C. sintering temperature of Mg2SiO4. The sintering temperature is still too high to be co-fired with Cu, Ag etc. because of high sintering temperature restricting its industrial application.

The normal method for decreasing ceramic sintering temperature typically comprises: adding the oxide or glass material with low melting point such as B2O3 or V2O5 etc. to produce a molten liquid phase at low temperature. The oxide or glass with low melting point benefit to sintering reaction of the ceramic material, leading to a decrease in original sintering temperature. However, though using above manner can decrease original sintering temperature of ceramic material, the property of original material will be effected or the follow-up processing will meet difficulty due to different properties (such as high frequency dielectric property) between the adding material and the original material.

In addition to decreasing the sintering temperature, the glass material is processed into a slurry with the microwave dielectric material to derive a high frequency multilayer capacitor device, in which PVA or PVB is always utilized by the slurry system as a binder, and according to the research report in prior art [J. Am. Ceram. Soc., 93 3049-3051(2010)] that there may be a cross-linking reaction between PVA or PVB and the flux B2O3 forming a three-dimensional (3-D) network gel structure such that the viscosity of the slurry is significantly increased; therefore, it is harmful to the coating process and cannot be applied to make a multilayer ceramic capacitor device. Unfortunately, however, the need persists for a material design employing a low temperature sintering process while also maintaining efficacious processing and electrical properties of ceramic material.

### SUMMARY OF THE INVENTION

To solve above technical disadvantages of conventional materials, the present invention is directed to providing a low-temperature co-fired microwave dielectric ceramic material and the preparation method thereof, i.e. sintering into a dense structure at a temperature of 900^{˜}970° C. and co-firing with Ag in ambient environment and with Cu in inert atmosphere; a microwave dielectric ceramic material having advantageous properties including low dielectric constant (8^{˜}15), high quality factor (Q factor), low capacitance-temperature coefficient for applications to such microwave dielectric devices as capacitor, ceramic filter, ceramic antenna etc.

To further address technical problems of conventional materials, a yet further purpose of the present invention is to provide co-firing at low temperature by adding an eutectic composition and developing a new glass material formulation. For (1−x) Mg2SiO4−xCa2SiO4 ceramic powder, if 0.2≦x≦0.7, there could be an eutectic composition. Thus, instead of sintering at 1300° C. into density originally, the ceramic material with eutectic composition is sintered into dense structure only at 1150° C. Both Mg2SiO4 and Ca2SiO4 are microwave dielectric ceramics having a low dielectric constant, their eutectic phase material having the property of low dielectric constant and high quality factor. To further adjust the dielectric property of this material formulation, additives CaTiO3 and CaZrO3 are mixed into the formulation. Next, the above ceramic material is combined into a glass slurry to compose a ceramic composite at a low sintering temperature (<1000° C.) by liquid phase sintering of glass material.

To solve a yet further technical problem of conventional materials, another purpose of the present invention is to further provide a ceramic composite with the low temperature sintering by the property of liquid phase sintering of glass material, wherein a Li2O—BaO—SrO—CaO—B2O3-SiO2 glass material has the property of high chemical stability obtained by mixing the powder of Li2O, BaO, SrO, CaO, B2O3 and SiO2 to melt at 1000-1300° C.; the composed glass material also has high structural stability in addition to provide the effect of sintering into a dense structure at low temperature for the ceramic powder, and may not react with water, methanol, ethanol, PVA and PVB, avoiding gel effect; and having efficacious plating resistance for conveniently applying to the process for multilayer capacitor device.

The present invention provides a low-temperature co-fired microwave dielectric ceramic material, which comprises: (a) 85 wt % to 99 wt % ceramic material, which is mainly 1−y−z[(1−x)Mg2SiO4−xCa2SiO4]−yCaTiO3−zCaZrO3, wherein 0.2≦x≦0.7, 0.05≦z≦0.4; and (b) 1 wt % to 15 wt % glass material mainly composed of Li2O—BaO—SrO—CaO—B2O3—SiO2.

Preferably, the glass material is mainly composed of Li2O—BaO—SrO—CaO—B2O3-SiO2, wherein Li2O accounts for a% (0% ≦a≦10%) in the glass material by weight; BaO accounts for b% (1%≦b≦15%) in the glass material by weight; SrO accounts for c% (1%≦c≦11%) in the glass material by weight; CaO accounts for d% (5%≦d≦23%) in the glass material by weight; B2O3 accounts for e% (5% ≦e≦30%) in the glass material by weight; SiO2 accounts for f% (20%≦f≦50%) in the glass material by weight, and a+b+c+d+e+f=100%.

Preferably, the dielectric constant of the low-temperature co-fired microwave dielectric ceramic material ranges from 8 to 15, the sintering density distribution is 3.17^{˜}3.52(g/cm3), the quality factor distribution is 2900^{˜}6500, and the insulation resistance property ≧3.5×10¹² Ω.

The present invention provides a preparation method for the low-temperature co-fired microwave dielectric ceramic material, which comprises: (a) mixing the ceramic material with the glass material of Li2O—BaO—SrO—CaO—B2O3-SiO2 at room temperature, wherein the ceramic material is composed of an eutectic phase composite of a Mg2SiO4 powder and a Ca2SiO4 powder with then addition of additives of a Mg2SiO4 powder and Ca2SiO4 powder; (b) sintering the mixed material at a low temperature of 900-970° C. for 0.5-4 hours.

Preferably, the Mg2SiO4 powder is obtained by calcining MgO and SiO2 at 900-1300° C. for 4-10 hours and then grinding for refinement.

Preferably, the Ca2SiO4 powder is obtained by calcining CaO and SiO2 at 900-1200° C. for 4-10 hours and then grinding for refinement.

Preferably, the CaTiO3 powder is obtained by calcining CaO and TiO2 at 900-1200° C. for 4-10 hours and then grinding for refinement.

Preferably, the CaZrO3 powder is obtained by calcining CaO and ZrO2 at 900-1200° C. for 4-10 hours and then grinding for refinement.

Preferably, the glass material of Li2O—BaO—SrO—CaO—B2O3-SiO2 is composed of 0-10 wt % Li2O powder, 1-15 wt % BaO powder, 1-11 wt % SrO powder, 5-23 wt % CaO powder, 5-30 wt % B2O3 powder and 20-50 wt % SiO2 powder, forming the glass material of Li2O—BaO—SrO—CaO—B2O3-SiO2 after being melted at 1000-1300° C. for 2-10 hours and then being ground for refinement.

The present invention provides another preparation method for low-temperature co-fired microwave dielectric ceramic material, which comprises: (a) mixing the ceramic material with the glass material of Li2O—BaO—SrO—CaO—B2O3—SiO2 at room temperature, wherein the ceramic material is composed of an eutectic phase composite composed by a Mg2SiO4 powder and Ca2SiO4 powder with addition of additives of a CaZrO3 powder and CaTiO3 powder; and (b) sintering the mixed material with Ag or Cu electrode at a low temperature of 900-970° C. for 0.5-4 hours.

Preferably, the Mg2SiO4 powder is obtained by calcining MgO and SiO2 at 900-1300° C. for 4-10 hours and then grinding for refinement.

Preferably, the Ca2SiO4 powder is obtained by calcining CaO and SiO2 at 900-1200° C. for 4-10 hours and then grinding for refinement.

Preferably, the CaTiO3 powder is obtained by calcining CaO and TiO2 at 900-1200° C. for 4-10 hours and then grinding for refinement.

Preferably, the CaZrO3 powder is obtained by calcining CaO and ZrO2 at 900-1200° C. for 4-10 hours and then grinding for refinement.

Preferably, the glass material of Li2O—BaO—SrO—CaO—B2O3-SiO2 is composed of 0-10 wt % Li2O powder, 1-15 wt % BaO powder, 1-11 wt % SrO powder, 5-23 wt % CaO powder, 5-30 wt % B2O3 powder and 20-50 wt % SiO2 powder, forming the glass material of Li2O—BaO—SrO—CaO—B2O3-SiO2 after being melted at 1000-1300° C. for 2-10 hours and then being ground for refinement.

### BRIEF DESCRIPTION OF THE DRAWINGS

The technical content and purpose of the present invention will be further understood with reference to the detailed description and accompanying drawings of the present invention; briefly described as follows:

FIG. 1 is a flow chart of low-temperature co-fired microwave dielectric ceramic material and preparation method thereof of the present invention;

FIG. 2 is another flow chart of low-temperature co-fired microwave dielectric ceramic material and preparation method thereof of the present invention; and

FIG. 3 is the surface morphology of the low-temperature co-fired microwave dielectric ceramic material adding with glass material after electroplating

### REFERENCE NUMERALS FOR MAIN DEVICES

S01^{˜}S02 step flow

S11^{˜}S12 step flow

### DETAILED DESCRIPTION OF THE PREFERRED EMBODIMENTS

The specific embodiments will be described as follows to illustrate the implementing aspects of the present invention, but not limit the scope intended to be protected by the present invention.

The first embodiment of the present invention provides a low-temperature co-fired microwave dielectric ceramic material comprising: 85 wt % to 99 wt % ceramic material and 1 wt % to 15 wt % glass material. The dielectric constant of the above microwave dielectric ceramic material is a low dielectric constant ranging from 8 to 15, and while having a microwave dielectric material with high quality factor and temperature frequency coefficient close to zero, the sintering density distribution thereof being 3.17^{˜}3.52(g/cm3), the quality factor distribution being 2900^{˜}6500, and the insulation resistance property ≧3.5×10¹² Ω.

The ceramic material is mainly 1—y—z[(1—x)Mg2SiO4—xCa2SiO4]—yCaTiO3—zCaZrO3. Through researching, for (1−x) Mg2SiO4−xCa2SiO4 ceramic powder, if 0.2≦x≦0.7, there could be an eutectic composition. The temperature for sintering the ceramic into dense structure may be decreased from original 1300° C. to 1150° C. At the same time, this eutectic phase material also has a property of low dielectric constant and high quality factor. Appropriate CaTiO3 and CaZrO3 are added for further adjustment of overall dielectric properties of the material after sintering, 1−y−z[(1−x)Mg2SiO4−xCa2SiO4]−yCaTiO3−zCaZrO composite is then obtained, wherein 0.2≦x≦0.7, 0.05≦y≦0.3, 0.02≦z≦0.15.

The glass material is mainly composed of Li2O—BaO—SrO—CaO—B2O3-SiO2, wherein Li2O accounts for a% (0%≦a≦10%) in the glass material by weight; BaO accounts for b% (1%≦b≦15%) in the glass material by weight; SrO accounts for c% (1%≦c≦11%) in the glass material by weight; CaO accounts for d% (5%≦d≦23%) in the glass material by weight; B2O3 accounts for e% (5%≦e≦30%) in the glass material by weight; SiO2 accounts for f% (20%≦g≦50%) in the glass material by weight, and a+b+c+d+e+f=100%.

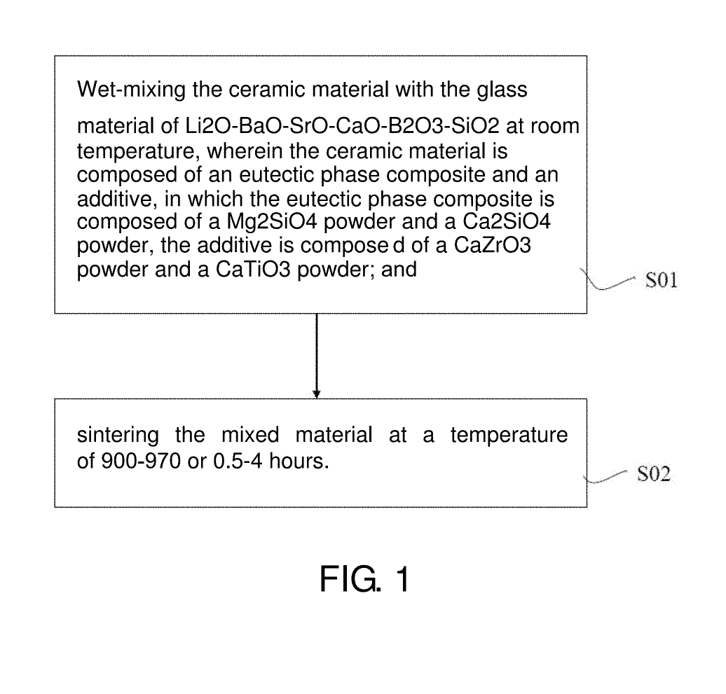

With reference to FIG. 1, the second embodiment of the present invention provides a preparation method for low-temperature co-fired microwave dielectric ceramic material comprising:

S01: Wet-mixing the ceramic material with the glass material of Li2O—BaO—SrO—CaO—B2O3-SiO2 at room temperature, wherein the ceramic material is composed of an eutectic phase composite and an additive, in which the eutectic phase composite is composed of a Mg2SiO4 powder and a Ca2SiO4 powder, the additive is composed of a CaZrO3 powder and a CaTiO3 powder; and
S02: sintering the mixed material at a temperature of 900-970° C. for 0.5-4 hours.
The ceramic material is composed of Mg2SiO4 powder, Ca2SiO4 powder, CaZrO3 powder and CaTiO3 powder. Wherein, the Mg2SiO4 powder is prepared by weighing MgO and SiO2 according to stoichiometric ratio thereof and calcining them at 900-1300° C. for 4-10 hours and then grinding the obtained product for refinement. The Ca2SiO4 powder is prepared by weighing CaO and SiO2 according to stoichiometric ratio thereof and calcining them at 900-1200° C. for 4-10 hours and then grinding the obtained product for refinement. The CaTiO3 powder is prepared by weighing CaO and TiO2 according to stoichiometric ratio thereof and calcining them at 900-1200° C. for 4-10 hours and then grinding the obtained product for refinement. The CaZrO3 powder is prepared by weighing CaO and ZrO2 according to stoichiometric ratio thereof and calcining them at 900-1200° C. for 4-10 hours and then grinding the obtained product for refinement.

The glass material of Li2O—BaO—SrO—CaO—B2O3-SiO2 is composed of 0-10 wt % Li2O powder, 1-10 wt % BaO powder, 1-10 wt % SrO powder, 5-20 wt % CaO powder, 5-30 wt % B2O3 powder and 10-50 wt % SiO2 powder, forming the glass material of Li2O—BaO—SrO—CaO—B2O3-SiO2 after being melted at 1000-1300° C. for 2-10 hours and then being ground for refinement. For the property of the glass material, in addition to provide an advantageous liquid sintering property when being co-fired with ceramic material, it also has a high chemical stability: not easily hydrolyzed in water or alcohol etc. and resistant to corrosion in electroplating baths (copper, nickel or tin). The glass material it further resistant to combining with ceramics to produce secondary phase reactants.

After adding water, alcohol, dispersant etc. for wet-mixing the Mg2SiO4 powder, Ca2SiO4 powder, CaZrO3 powder and CaTiO3 powder with Li2O—BaO—SrO—CaO—B2O3-SiO2 glass material for 2 hours, then filtering to dry. Sintering the mixed material at a low temperature of 900-970° C., and may co-fire them with Ag or Cu for 0.5-4 hours, then the dielectric constant of the above microwave dielectric ceramic material becomes a low dielectric constant ranging from 8 to 15, and while becoming a microwave dielectric material with high quality factor and temperature frequency coefficient close to zero, the sintering density distribution thereof is 3.17^{˜}3.52(g/cm3), the quality factor distribution is 2900^{˜6500,} and the insulation resistance property ≧3.5×10¹² Ω.

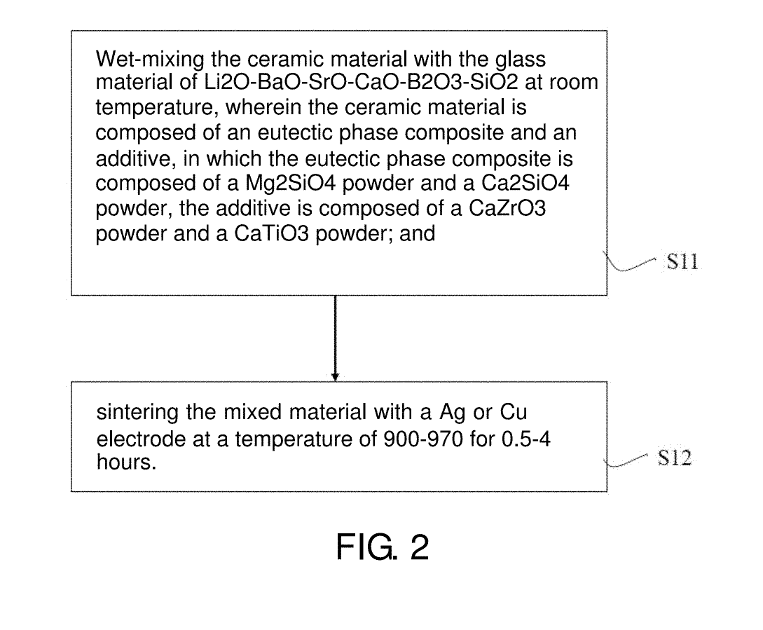

With reference to FIG. 2, the third embodiment of the present invention provides another preparation method for low-temperature co-fired microwave dielectric ceramic material comprising:

S11: Wet-mixing the ceramic material with the glass material of Li2O—BaO—SrO—CaO—B2O3-SiO2 at room temperature, wherein the ceramic material is composed of an eutectic phase composite and an additive, in which the eutectic phase composite is composed of a Mg2SiO4 powder and a Ca2SiO4 powder, the additive is composed of a CaZrO3 powder and a CaTiO3 powder; and S12: Sintering the mixed material with a Ag or Cu electrode at a temperature of 900-970° C. for 0.5-4 hours.

The preparation manner for ceramic material and glass material in the third embodiment of the present invention is similar to that in the second embodiment, and will not be described in detail in the present embodiment.

According to the formulation in the present invention: 85 wt % to 99 wt % ceramic material 1−y−z[(1−x)Mg2SiO4−xCa2SiO4]−yCaTiO3−zCaZrO31 is mixed with 1 wt % to 15 wt % glass material of Li2O—BaO—SrO—CaO—B2O3-SiO2, and after mixing ceramic material in the proportion of different x, y and z with that in different glass/ceramic ingredient proportions, pressing into disk and coating Ag or Cu electrode onto the disk for co-firing, and then the physical and dielectric properties of different ceramic composites after sintering are shown in Table 1 wherein, the quality factor is obtained by inversing the dispassion factor of sintered body that is measured through a capacitance meter at 1 MHz communication signal by way of biasing 1 Vrms; and for temperature-capacitance coefficient measurement, ΔC/C, ΔC/C is obtained by observing the capacitance variants ΔC at −55° C.^{˜}125° C. based on the device capacitance measured at room temperature of 25° C.

Experiment 1-1: when x=0.2, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.05, z=0.02, is mixed with 1 wt % Li2O—BaO—SrO—CaO—B2O3-SiO2 glass material for co-firing test with Cu electrode at 970° C. to prepare a low-temperature co-fired microwave dielectric ceramic material with density of 3.23(g/cm3); quality factor (Q) point of 6250; dielectric constant and capacitance-temperature coefficient of 8.5 and —14 ppm/° C. respectively; insulation resistance of 5.2×10¹² Ω.

Experiment 1-2: when x=0.2, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.05, z=0.02, is mixed with 1 wt % Li2O—BaO—SrO—CaO—B2O3-SiO2 glass material for co-firing test with Ag electrode at 915° C. to prepare a low-temperature co-fired microwave dielectric ceramic material with density of 3.17(g/cm3); quality factor (Q) of 5882; dielectric constant and capacitance-temperature coefficient of 8.1 and −15 ppm/° C. respectively; insulation resistance of 4.2×10¹² Ω.

Experiment 1-3: when x=0.2, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.1, z=0.05, is mixed with 5 wt % Li2O—BaO—SrO—CaO—B2O3-SiO2 glass material for co-firing test with Cu electrode at 970° C. to prepare a low-temperature co-fired microwave dielectric ceramic material with density of 3.28(g/cm3); quality factor (Q) of 6666; dielectric constant and capacitance-temperature coefficient of 9.6 and 18 ppm/° C. respectively; insulation resistance of 5.4×10¹² Ω.

Experiment 1-4: when x=0.2, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.1, z=0.05, is mixed with 5 wt % Li2O—BaO—SrO—CaO—B2O3-SiO2 glass material for co-firing test with Ag electrode at 910° C. to prepare a low-temperature co-fired microwave dielectric ceramic material with density of 3.22(g/cm3); quality factor (Q) point of 6250; dielectric constant and capacitance-temperature coefficient of 9.5 and 19 ppm/° C. respectively; insulation resistance of 4.4×10¹² Ω.

Experiment 1-5: when x=0.2, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.2, z=0.1, is mixed with 10 wt % Li2O—BaO—SrO—CaO—B2O3-SiO2 glass material for co-firing test with Cu electrode at 970° C. to prepare a low-temperature co-fired microwave dielectric ceramic material with density of 3.35(g/cm3); quality factor (Q) of 4762; dielectric constant and capacitance-temperature coefficient of 11.8 and 46 ppm/° C., respectively; insulation resistance of 3.9×10¹² Ω.

Experiment 1-6: when x=0.2, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.2, z=0.1, is mixed with 10 wt % Li2O—BaO—SrO—CaO—B2O3-SiO2 glass material for co-firing test with Ag electrode at 905° C. to prepare a low-temperature co-fired microwave dielectric ceramic material with density of 3.32(g/cm3); quality factor (Q) of 4545; dielectric constant and capacitance-temperature coefficient of 11.9 and 37 ppm/° C., respectively; insulation resistance of 3.5×10¹² Ω.

Experiment 1-7: when x=0.2, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.3, z=0.15, is mixed with 15 wt % Li2O—BaO—SrO—CaO—B2O3-SiO2 glass material for co-firing test with Cu electrode at 970° C. to prepare a low-temperature co-fired microwave dielectric ceramic material with density of 3.34(g/cm3); quality factor (Q) of 4347; dielectric constant and capacitance-temperature coefficient of 11.9 and 47 ppm/° C. respectively; insulation resistance of 3.7×10¹² Ω.

Experiment 1-8: when x=0.2, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.3, z=0.15, is mixed with 15 wt % Li2O—BaO—SrO—CaO—B2O3-SiO2 glass material for co-firing test with Ag electrode at 900° C. to prepare a low-temperature co-fired microwave dielectric ceramic material with density of 3.31(g/cm3); quality factor (Q) point of 4167; dielectric constant and capacitance-temperature coefficient of 12 and 40 ppm/° C. respectively; insulation resistance property of 3.8×10¹² Ω.

Experiment 2-1: when x=0.4, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.05, z=0.02, is mixed with 1 wt % Li2O—BaO—SrO—CaO—B2O3-SiO2 glass material for co-firing test with Cu electrode at 970° C. to prepare a low-temperature co-fired microwave dielectric ceramic material with density of 3.25(g/cm3); quality factor (Q) of 5263; dielectric constant and capacitance-temperature coefficient of 8.4 and —17 ppm/° C. respectively; insulation resistance property of 4.9×10¹² Ω.

Experiment 2-2: when x=0.4, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.05, z=0.02, is mixed with 1 wt % Li2O—BaO—SrO—CaO—B2O3-SiO2 glass material for co-firing test with Ag electrode at 915° C. to prepare a low-temperature co-fired microwave dielectric ceramic material with density of 3.21(g/cm3); quality factor (Q) point of 5000; dielectric constant and capacitance-temperature coefficient of 8.1 and —15 ppm/° C. respectively; insulation resistance property of 4.3×10¹² Ω.

Experiment 2-3: when x=0.4, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.1, z=0.05, is mixed with 5 wt % Li2O—BaO—SrO—CaO—B2O3-SiO2 glass material for co-firing test with Cu electrode at 970° C. to prepare a low-temperature co-fired microwave dielectric ceramic material with density of 3.30(g/cm3); quality factor (Q) of 5555; dielectric constant and capacitance-temperature coefficient of 11.7 and 17 ppm/° C. respectively; insulation resistance property of 5.6×10¹² Ω.

Experiment 2-4: when x=0.4, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.1, z=0.05, is mixed with 5 wt % Li2O—BaO—SrO—CaO—B2O3-SiO2 glass material for co-firing test with Ag electrode at 910° C. to prepare a low-temperature co-fired microwave dielectric ceramic material with density of 3.25(g/cm3); quality factor (Q) point of 5263; dielectric constant and capacitance-temperature coefficient of 11.6 and 18 ppm/° C. respectively; insulation resistance of 4.7×10¹² Ω.

Experiment 2-5: when x=0.4, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.2, z=0.1, is mixed with 10 wt % Li2O—BaO—SrO—CaO—B2O3-SiO2 glass material for co-firing test with Cu electrode at 970° C. to prepare a low-temperature co-fired microwave dielectric ceramic material with sintering density distribution of 3.38(g/cm3); quality factor (Q) point of 4545; dielectric constant and capacitance-temperature coefficient of 11.8 and 46 ppm/° C. respectively; insulation resistance property of 4.8×10¹² Ω.

Experiment 2-6: when x=0.4, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.2, z=0.1, is mixed with 10 wt % Li2O—BaO—SrO—CaO—B2O3-SiO2 glass material for co-firing test with Ag electrode at 905° C. to prepare a low-temperature co-fired microwave dielectric ceramic material with density of 3.42(g/cm3); quality factor (Q) of 4347; dielectric constant and capacitance-temperature coefficient of 11.6 and 44 ppm/° C. respectively; insulation resistance property of 3.9×10¹² Ω.

Experiment 2-7: when x=0.4, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.3, z=0.15, is mixed with 15 wt % Li2O—BaO—SrO—CaO—B2O3-SiO2 glass material for co-firing test with Cu electrode at 970° C. to prepare a low-temperature co-fired microwave dielectric ceramic material with density of 3.37(g/cm3); quality factor (Q) point of 3846; dielectric constant and capacitance-temperature coefficient of 14.2 and 47 ppm/° C. respectively; insulation resistance property of 4.4×10¹² Ω.

Experiment 2-8: when x=0.4, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.3, z=0.15, is mixed with 15 wt % Li2O—BaO—SrO—CaO—B2O3-SiO2 glass material for co-firing test with Ag electrode at 900° C. to prepare a low-temperature co-fired microwave dielectric ceramic material with density of 3.40(g/cm3); quality factor (Q) of 3704; dielectric constant and capacitance-temperature coefficient of 14 and 46 ppm/° C. respectively; insulation resistance of 3.9×10¹² Ω.

Experiment 3-1: when x=0.5, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.05, z=0.02, is mixed with 1 wt % Li2O—BaO—SrO—CaO—B2O3-SiO2 glass material for co-firing test with Cu electrode at 970° C. to prepare a low-temperature co-fired microwave dielectric ceramic material with density of 3.28(g/cm3); quality factor (Q) point of 4545; dielectric constant and capacitance-temperature coefficient of 8.5 and —17 ppm/° C. respectively; insulation resistance of 5.3×10¹² Ω.

Experiment 3-2: when x=0.5, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.05, z=0.02, is mixed with 1 wt % Li2O—BaO—SrO—CaO—B2O3-SiO2 glass material for co-firing test with Ag electrode at 915° C. to prepare a low-temperature co-fired microwave dielectric ceramic material with density of 3.25(g/cm3); quality factor (Q) point of 4347; dielectric constant and capacitance-temperature coefficient of 8.2 and —19 ppm/° C. respectively; insulation resistance of 4.3×10¹² Ω.

Experiment 3-3: when x=0.5, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.1, z=0.05, is mixed with 5 wt % Li2O—BaO—SrO—CaO—B2O3-SiO2 glass material for co-firing test with Cu electrode at 970° C. to prepare a low-temperature co-fired microwave dielectric ceramic material with density of 3.36(g/cm3); quality factor (Q) of 4762; dielectric constant and capacitance-temperature coefficient of 9.6 and 15 ppm/° C. respectively; insulation resistance property of 5.7×10¹² Ω.

Experiment 3-4: when x=0.5, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.1, z=0.05, is mixed with 5 wt % Li2O—BaO—SrO—CaO—B2O3-SiO2 glass material for co-firing test with Ag electrode at 910° C. to prepare a low-temperature co-fired microwave dielectric ceramic material with sintering density distribution of 3.32(g/cm3); quality factor (Q) point of 4545; dielectric constant and capacitance-temperature coefficient of 9.5 and 14 ppm/° C. respectively; insulation resistance property of 5.2×10¹² Ω.

Experiment 3-5: when x=0.5, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.2, z=0.1, is mixed with 10 wt % Li2O—BaO—SrO—CaO—B2O3-SiO2 glass material for co-firing test with Cu electrode at 970° C. to prepare a low-temperature co-fired microwave dielectric ceramic material with sintering density distribution of 3.45(g/cm3); quality factor (Q) of 3846; dielectric constant and capacitance-temperature coefficient of 11.8 and 45 ppm/° C. respectively; insulation resistance of 4.9×10¹² Ω.

Experiment 3-6: when x=0.5, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.2, z=0.1, is mixed with 10 wt % Li2O—BaO—SrO—CaO—B2O3-SiO2 glass material for co-firing test with Ag electrode at 905° C. to prepare a low-temperature co-fired microwave dielectric ceramic material with sintering density distribution of 3.41(g/cm3); quality factor (Q) of 3571; dielectric constant and capacitance-temperature coefficient of 11.7 and 45 ppm/° C. respectively; insulation resistance of 3.9×10¹² Ω.

Experiment 3-7: when x=0.5, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.3, z=0.15, is mixed with 15 wt % Li2O—BaO—SrO—CaO—B2O3-SiO2 glass material for co-firing test with Cu electrode at 970° C. to prepare a low-temperature co-fired microwave dielectric ceramic material with density of 3.44(g/cm3); quality factor (Q) point of 3704; dielectric constant and capacitance-temperature coefficient of 11.9 and 46 ppm/° C. respectively; insulation resistance of 4.4×10¹² Ω.

Experiment 3-8: when x=0.5, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.3, z=0.15, is mixed with 15 wt % Li2O—BaO—SrO—CaO—B2O3-SiO2 glass material for co-firing test with Ag electrode at 900° C. to prepare a low-temperature co-fired microwave dielectric ceramic material with density of 3.42(g/cm3); quality factor (Q) point of 3448; dielectric constant and capacitance-temperature coefficient of 12 and 47 ppm/° C. respectively; insulation resistance of 4.0×10¹² Ω.

Experiment 4-1: when x=0.7, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.05, z=0.02, is mixed with 1 wt % Li2O—BaO—SrO—CaO—B2O3-SiO2 glass material for co-firing test with Cu electrode at 970° C. to prepare a low-temperature co-fired microwave dielectric ceramic material with density of 3.31(g/cm3); quality factor (Q) point of 4000; dielectric constant and capacitance-temperature coefficient of 8.5 and —19 ppm/° C. respectively; insulation resistance of 5.3×10¹² Ω.

Experiment 4-2: when x=0.7, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.05, z=0.02, is mixed with 1 wt % Li2O—BaO—SrO—CaO—B2O3-SiO2 glass material for co-firing test with Ag electrode at 915° C. to prepare a low-temperature co-fired microwave dielectric ceramic material with density of 3.26(g/cm3); quality factor (Q) of 3846; dielectric constant and capacitance-temperature coefficient of 7.9 and —15 ppm/° C. respectively; insulation resistance of 5.1×10¹² Ω.

Experiment 4-3: when x=0.7, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.1, z=0.05, is mixed with 5 wt % Li2O—BaO—SrO—CaO—B2O3-SiO2 glass material for co-firing test with Cu electrode at 970° C. to prepare a low-temperature co-fired microwave dielectric ceramic material with density of 3.41(g/cm3); quality factor (Q) point of 4167; dielectric constant and capacitance-temperature coefficient of 9.6 and 14 ppm/° C. respectively; insulation resistance of 6.7×10¹² Ω.

Experiment 4-4: when x=0.7, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.1, z=0.05, is mixed with 5 wt % Li2O—BaO—SrO—CaO—B2O3-SiO2 glass material for co-firing test with Ag electrode at 910° C. to prepare a low-temperature co-fired microwave dielectric ceramic material with density of 3.31(g/cm3); quality factor (Q) point of 4000; dielectric constant and capacitance-temperature coefficient of 9.4 and 15 ppm/° C. respectively; insulation resistance of 6.2×10¹² Ω.

Experiment 4-5: when x=0.7, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.2, z=0.1, is mixed with 10 wt % Li2O—BaO—SrO—CaO—B2O3-SiO2 glass material for co-firing test with Cu electrode at 970° C. to prepare a low-temperature co-fired microwave dielectric ceramic material with density of 3.50(g/cm3); quality factor (Q) point of 3448; dielectric constant and capacitance-temperature coefficient of 11.8 and 45 ppm/° C. respectively; insulation resistance of 4.8×10¹² Ω.

Experiment 4-6: when x=0.7, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.2, z=0.1, is mixed with 10 wt % Li2O—BaO—SrO—CaO—B2O3-SiO2 glass material for co-firing test with Ag electrode at 905° C. to prepare a low-temperature co-fired microwave dielectric ceramic material with density of 3.43(g/cm3); quality factor (Q) point of 3226; dielectric constant and capacitance-temperature coefficient of 11.6 and 39 ppm/° C. respectively; insulation resistance of 4.7×10¹² Ω.

Experiment 4-7: when x=0.7, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.3, z=0.15, is mixed with 15 wt % Li2O—BaO—SrO—CaO—B2O3-SiO2 glass material for co-firing test with Cu electrode at 970° C. to prepare a low-temperature co-fired microwave dielectric ceramic material with density of 3.52(g/cm3); quality factor (Q) point of 3125; dielectric constant and capacitance-temperature coefficient of 11.9 and 46 ppm/° C. respectively; insulation resistance of 4.6×10¹² Ω.

Experiment 4-8: when x=0.7, (1−x)Mg2SiO4−xCa2SiO4 ceramic material carrying 1−y−z[(1−x)Mg2SiO4−xCa2SiO4]−yCaTiO3−zCaZrO3 in different adding proportions, wherein y=0.3, z=0.15, is mixed with 15 wt % Li2O—BaO—SrO—CaO—B2O3-SiO2 glass material for co-firing test with Ag electrode at 900° C. to prepare a low-temperature co-fired microwave dielectric ceramic material with density of 3.46(g/cm3); quality factor (Q) point of 2941; dielectric constant and capacitance-temperature coefficient of 11.8 and 44 ppm/° C. respectively; insulation resistance of 4.3×10¹² Ω.

As shown in Table 1, the density of sintered body raises with the adding amount of glass increases and the sintering density distribution is 3.17⁻3.52(g/cm3); the quality factor property correlates with the adding proportion of main material with high microwave property and the density after sintering, and the quality factor distribution is 2914^{˜}6250; the dielectric constant and capacitance-temperature coefficient falls on respectively: 8.1^{˜}14.2 and −19^{˜}46 ppm/° C. In all, after being sintered with Ag or Cu, the sintered material has low dielectric constant property, and high quality factor, efficacious temperature-capacitance coefficient and high insulation resistance property (≧3.7×10¹² Ω).

With reference to Table 2, results of sintering property are shown when 90 wt % 0.7[0.5Mg2SiO4-0.5Ca2SiO4]-0.2CaTiO3-0.1CaZrO3 is mixed with 10 wt % Li2O—BaO—SrO—CaO—ZnO—B2O3-SiO2 glass material with different formulation at 900° C. The components adding into the Li2O—BaO—SrO—CaO—B2O3-SiO2 glass material are: Li2O accounting for a% in the glass material by weight, 0%≦a≦10%; BaO accounting for b% in the glass material by weight, 1%≦b≦15%; SrO accounting for c% in the glass material by weight, 1%≦c≦11%; CaO accounting for d% in the glass material by weight, 5%≦d≦23%; B2O3 accounting for e% in the glass material by weight, 5%≦e≦30%; SiO2 accounting for f% in the glass material by weight, 20%≦f≦50%, wherein a+b+c+d+e+f=100%.

Experiment 5-1: When 90 wt % 0.7[0.5Mg2SiO4-0.5Ca2SiO4]-0.2CaTiO3-0.1CaZrO3 being mixed with 10 wt % Li2O—BaO—SrO—CaO—ZnO—B2O3-SiO2 glass material with different formulation is co-fired with Cu electrode at 970° C. Wherein, the components adding into the Li2O—BaO—SrO—CaO—B2O3-SiO2 glass material are: Li2O accounting for 10% in the glass material by weight; BaO accounting for 10% in the glass material by weight; SrO accounting for 11% in the glass material by weight; CaO accounting for 14% in the glass material by weight; B2O3 accounting for 5% in the glass material by weight; SiO2 accounting for 50% in the glass material by weight. The prepared low-temperature co-fired microwave dielectric ceramic material has a density of 3.45(g/cm3); quality factor (Q) point of 3846; dielectric constant and capacitance-temperature coefficient of 11.8 and 45 ppm/° C. respectively; insulation resistance of 4.9×10¹² Ω.

Experiment 5-2: When 90 wt % 0.7[0.5Mg2SiO4-0.5Ca2SiO4]-0.2CaTiO3-0.1CaZrO3 being mixed with 10 wt % Li2O—BaO—SrO—CaO—ZnO—B2O3-SiO2 glass material with different formulation is co-fired with Cu electrode at 935° C. Wherein, the components adding into the Li2O—BaO—SrO—CaO—B2O3-SiO2 glass material are: Li2O accounting for 9% in the glass material by weight; BaO accounting for 1% in the glass material by weight; SrO accounting for 10% in the glass material by weight; CaO accounting for 5% in the glass material by weight; B2O3 accounting for 29% in the glass material by weight; SiO2 accounting for 46% in the glass material by weight. The prepared low-temperature co-fired microwave dielectric ceramic material has a density of 3.4(g/cm3); quality factor (Q) point of 3923; dielectric constant and capacitance-temperature coefficient of 12.3 and 40 ppm/° C. respectively; insulation resistance of 5.9×10¹² Ω.

Experiment 5-3: When 90 wt % 0.7[0.5Mg2SiO4-0.5Ca2SiO4]-0.2CaTiO3-0.1CaZrO3 being mixed with 10 wt % Li2O—BaO—SrO—CaO—ZnO—B2O3-SiO2 glass material with different formulation is co-fired with Cu electrode at 960° C. Wherein, the components adding into the Li2O—BaO—SrO—CaO—B2O3-SiO2 glass material are: Li2O accounting for 8% in the glass material by weight; BaO accounting for 10% in the glass material by weight; SrO accounting for 8% in the glass material by weight; CaO accounting for 19% in the glass material by weight; B2O3 accounting for 20% in the glass material by weight; SiO2 accounting for 35% in the glass material by weight. The prepared low-temperature co-fired microwave dielectric ceramic material has a density of 3.35(g/cm3); quality factor (Q) point of 4005; dielectric constant and capacitance-temperature coefficient of 12.6 and 35 ppm/° C. respectively; insulation resistance of 6.2×10¹² Ω.

Experiment 5-4: When 90 wt % 0.7[0.5Mg2SiO4-0.5Ca2SiO4]-0.2CaTiO3-0.1CaZrO3 being mixed with 10 wt % Li2O—BaO—SrO—CaO—ZnO—B2O3-SiO2 glass material with different formulation is co-fired with Cu electrode at 930° C. Wherein, the components adding into the Li2O—BaO—SrO—CaO—B2O3-SiO2 glass material are: Li2O accounting for 5% in the glass material by weight; BaO accounting for 14% in the glass material by weight; SrO accounting for 10% in the glass material by weight; CaO accounting for 23% in the glass material by weight; B2O3 accounting for 28% in the glass material by weight; SiO2 accounting for 20% in the glass material by weight. The prepared low-temperature co-fired microwave dielectric ceramic material has a density of 3.38(g/cm3); quality factor (Q) of 4265; dielectric constant and capacitance-temperature coefficient of 11.8 and 37 ppm/° C. respectively; insulation resistance of 7.9×10¹² Ω.

Experiment 5-5: When 90 wt % 0.7[0.5Mg2SiO4-0.5Ca2SiO4]-0.2CaTiO3-0.1CaZrO3 being mixed with 10 wt % Li2O—BaO—SrO—CaO—ZnO—B2O3-SiO2 glass material with different formulation is co-fired with Cu electrode at 920° C. Wherein, the components adding into the Li2O—BaO—SrO—CaO—B2O3-SiO2 glass material are: Li2O accounting for 0% in the glass material by weight; BaO accounting for 15% in the glass material by weight; SrO accounting for 1% in the glass material by weight; CaO accounting for 17% in the glass material by weight; B2O3 accounting for 30% in the glass material by weight; SiO2 accounting for 37% in the glass material by weight. The prepared low-temperature co-fired microwave dielectric ceramic material has a density of 3.33(g/cm3); quality factor (Q) point of 4201; dielectric constant and capacitance-temperature coefficient of 12.5 and 40 ppm/° C. respectively; insulation resistance of 3.9×10¹² Ω.

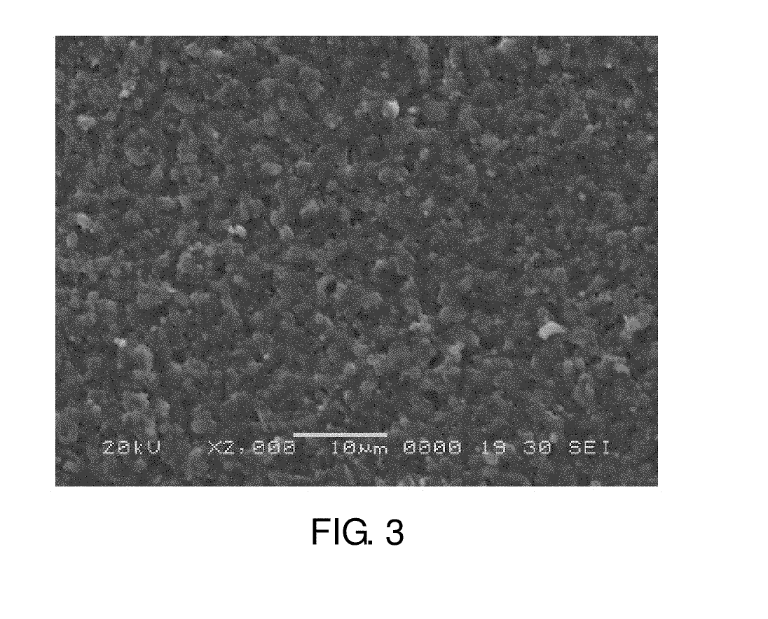

As shown in Table 2, the quality factor is in the range from 3846 to 4065; the dielectric constant and capacitance-temperature coefficient ranges from 11.8 to12.5 and from 35 to 45 ppm/° C., respectively. In all, after being sintered with Cu, the sintered material has low dielectric constant and efficacious temperature-capacitance coefficient and insulation resistance property (≧3.7×1012 Ω). The ceramic slip prepared by alcohol with toluene and polyvinyl butyral (PVB) was a stable slip did not react with PVB and thus the gel effect did not occur, the slip viscosity being 350^{˜}450 cps; and the ceramic body made through sintering has a good anti-corrosion properties in plating solution, which has pH value less than 3. FIG. 3 shows a surface morphology of the microwave dielectric material after electroplating, which has no pinhole on the surface.

In summary, the present invention has not only inventiveness on technical idea but also has the effect that conventional structure doesn't have, it has been fully consistent with the novelty and progressiveness of the statutory invention patent, thus apply according to law, and we pledge you office to approve this application, we will extend our sincere thanks to you office.

TABLE 1
Results of sintering property are shown when (100-m)wt % 1[0.5Mg2SiO4—0.5Ca2SiO4]—0.2CaTiO3—0.1CaZrO3
is mixed with (m)wt % Li2O—BaO—SrO—CaO—ZnO—B2O3—SiO2 glass material with different formulation at 900° C.
(CS: Ca2SiO4, MS: Mg2SiO4, CT: CaTiO3, CZ: CaZrO3)

| | | X | | | | | | | | | | temperature | |
|---|---|---|---|---|---|---|---|---|---|---|---|---|---|
| | Oxide | pro- | 1-X | Y | Z | Glass | Sintering | co- | | | quality | capacitance | insulation |
| | (1-m | portion | proportion | proportion | proportion | (m | Temp | firing | density | dielectric | fator | coefficient | resistance |
| Item | %) | CS | MS | CT | CZ | wt %) | (° C.) | metal | (g/cm³) | constant | (Q) | (ppm/° C.) | (Ω) |
| Test 1-1 | 99 | 0.2 | 0.8 | 0.05 | 0.02 | 1 | 970 | Cu | 3.23 | 8.5 | 6,250 | −14 | 5.2 * 10¹² |
| Test 1-2 | | | | | | | 915 | Ag | 3.17 | 8.1 | 5,882 | −15 | 4.2 * 10¹² |
| Test 1-3 | 95 | | | 0.1 | 0.05 | 5 | 970 | Cu | 3.28 | 9.6 | 6,666 | 18 | 5.4 * 10¹² |
| Test 1-4 | | | | | | | 910 | Ag | 3.22 | 9.5 | 6,250 | 19 | 4.4 * 10¹² |
| Test 1-5 | 90 | | | 0.2 | 0.1 | 10 | 970 | Cu | 3.35 | 11.8 | 4,762 | 46 | 3.9 * 10¹² |
| Test 1-6 | | | | | | | 905 | Ag | 3.32 | 11.9 | 4,545 | 37 | 3.5 * 10¹² |
| Test 1-7 | 85 | | | 0.3 | 0.15 | 15 | 970 | Cu | 3.34 | 11.9 | 4,347 | 47 | 3.7 * 10¹² |
| Test 1-8 | | | | | | | 900 | Ag | 3.31 | 12 | 4,167 | 40 | 3.8 * 10¹² |
| Test 2-1 | 99 | 0.4 | 0.6 | 0.05 | 0.02 | 1 | 970 | Cu | 3.25 | 8.4 | 5,263 | −17 | 4.9 * 10¹² |
| Test 2-2 | | | | | | | 915 | Ag | 3.21 | 8.1 | 5,000 | −15 | 4.3 * 10¹² |
| Test 2-3 | 95 | | | 0.1 | 0.05 | 5 | 970 | Cu | 3.30 | 11.7 | 5,555 | 17 | 5.6 * 10¹² |
| Test 2-4 | | | | | | | 910 | Ag | 3.25 | 11.6 | 5,263 | 18 | 4.7 * 10¹² |
| Test 2-5 | 90 | | | 0.2 | 0.1 | 10 | 970 | Cu | 3.38 | 11.8 | 4,545 | 46 | 4.8 * 10¹² |
| Test 2-6 | | | | | | | 905 | Ag | 3.42 | 11.6 | 4,347 | 44 | 3.9 * 10¹² |
| Test 2-7 | 85 | | | 0.3 | 0.15 | 15 | 970 | Cu | 3.37 | 14.2 | 3,846 | 47 | 4.4 * 10¹² |
| Test 2-8 | | | | | | | 900 | Ag | 3.40 | 14 | 3,704 | 46 | 3.9 * 10¹² |
| Test 3-1 | 99 | 0.5 | 0.5 | 0.05 | 0.02 | 1 | 970 | Cu | 3.28 | 8.5 | 4,545 | −17 | 5.3 * 10¹² |
| Test 3-2 | | | | | | | 915 | Ag | 3.25 | 8.2 | 4,347 | −19 | 4.3 * 10¹² |
| Test 3-3 | 95 | | | 0.1 | 0.05 | 5 | 970 | Cu | 3.36 | 9.6 | 4,762 | 15 | 5.7 * 10¹² |
| Test 3-4 | | | | | | | 910 | Ag | 3.32 | 9.5 | 4,545 | 14 | 5.2 * 10¹² |
| Test 3-5 | 90 | | | 0.2 | 0.1 | 10 | 970 | Cu | 3.45 | 11.8 | 3,846 | 45 | 4.9 * 10¹² |
| Test 3-6 | | | | | | | 905 | Ag | 3.41 | 11.7 | 3,571 | 45 | 3.9 * 10¹² |
| Test 3-7 | 85 | | | 0.3 | 0.15 | 15 | 970 | Cu | 3.44 | 11.9 | 3,704 | 46 | 4.4 * 10¹² |
| Test 3-8 | | | | | | | 900 | Ag | 3.42 | 12 | 3,448 | 47 | 4.0 * 10¹² |
| Test 4-1 | 99 | 0.7 | 0.3 | 0.05 | 0.02 | 1 | 970 | Cu | 3.31 | 8.5 | 4,000 | −19 | 5.3 * 10¹² |
| Test 4-2 | | | | | | | 915 | Ag | 3.26 | 7.9 | 3,846 | −15 | 5.1 * 10¹² |
| Test 4-3 | 95 | | | 0.1 | 0.05 | 5 | 970 | Cu | 3.41 | 9.6 | 4,167 | 14 | 6.7 * 10¹² |
| Test 4-4 | | | | | | | 910 | Ag | 3.31 | 9.4 | 4,000 | 15 | 6.2 * 10¹² |
| Test 4-5 | 90 | | | 0.2 | 0.1 | 10 | 970 | Cu | 3.50 | 11.8 | 3,448 | 45 | 4.8 * 10¹² |
| Test 4-6 | | | | | | | 905 | Ag | 3.43 | 11.6 | 3,226 | 39 | 4.7 * 10¹² |
| Test 4-7 | 85 | | | 0.3 | 0.15 | 15 | 970 | Cu | 3.52 | 11.9 | 3,125 | 46 | 4.6 * 10¹² |
| Test 4-8 | | | | | | | 900 | Ag | 3.46 | 11.8 | 2,941 | 44 | 4.3 * 10¹² |

TABLE 2
Results of sintering property are shown when 90 wt % 0.7[0.5Mg2SiO4—0.5Ca2SiO4]—0.2CaTiO3—0.1CaZrO3
is mixed with 10 wt % Li2O—BaO—SrO—CaO—ZnO—B2O3—SiO2 glass material with different formulation at 900° C.
(CS: Ca2SiO4, MS: Mg2SiO4, CT: CaTiO3, CZ: CaZrO3)

| | | | | | | | | | | | | | temperature- | |
|---|---|---|---|---|---|---|---|---|---|---|---|---|---|---|
| glass | Li₂O | BaO | | | | | | Sintering | co- | | | quality | capacitance | insulation |
| formu- | (wt | (wt | SrO | CaO | B₂O₃ | SiO₂ | slurry | Temp | firing | density | dielectric | fator | coefficient | resistance |
| lation | %) | %) | (wt %) | (wt %) | (wt %) | (wt %) | viscosity | (° C.) | metal | (g/cm³) | constant | (Q) | (ppm/° C.) | (Ω) |
| Test 5-1 | 10 | 10 | 11 | 14 | 5 | 50 | 350 | 970 | Cu | 3.45 | 11.8 | 3,846 | 45 | 4.9 * 10¹² |
| Test 5-2 | 9 | 1 | 10 | 5 | 29 | 46 | 400 | 935 | Cu | 3.4 | 12.3 | 3,923 | 40 | 5.9 * 10¹² |
| Test 5-3 | 8 | 10 | 8 | 19 | 20 | 35 | 430 | 960 | Cu | 3.35 | 12.6 | 4,005 | 35 | 6.2 * 10¹² |
| Test 5-4 | 5 | 14 | 10 | 23 | 28 | 20 | 450 | 930 | Cu | 3.38 | 11.8 | 4,265 | 37 | 7.9 * 10¹² |
| Test 5-5 | 0 | 15 | 1 | 17 | 30 | 37 | 400 | 920 | Cu | 3.33 | 12.5 | 4,201 | 40 | 3.9 * 10¹² |

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A low-temperature co-fired microwave dielectric ceramic material comprising:
(a) 85 wt % to 99 wt % ceramic material, which is 1−y−z[(1−x)Mg2SiO4−xCa2SiO4]−yCaTiO3−zCaZrO3, wherein 0.2×0.7, 0.05z0.4; and
(b) 1 wt % to 15 wt % glass material, which is mainly composed of Li2O—BaO—SrO—CaO—B2O3-SiO2.

2. The low-temperature co-fired microwave dielectric ceramic material according to claim 1, wherein the glass material is mainly composed of Li2O—BaO—SrO—CaO—B2O3-SiO2, wherein Li2O accounts for a% (0%≦a≦10%) in the glass material by weight; BaO accounts for b% (1%≦b≦15%) in the glass material by weight; SrO accounts for c% (1%≦c≦11%) in the glass material by weight; CaO accounts for d% (5%≦d≦23%) in the glass material by weight; B2O3 accounts for e% (5%≦e≦30%) in the glass material by weight; SiO2 accounts for f% (20%≦f≦50%) in the glass material by weight, and a+b+c+d+e+f=100%.

3. The low-temperature co-fired microwave dielectric ceramic material according to claim 1, wherein a dielectric constant of the low-temperature co-fired microwave dielectric ceramic material ranges from 8 to 15, the density is in the range from 3.17 to 3.52(g/cm3), a quality factor ranges from 2900 to 6500, and an insulation resistance ≧3.7×10¹² Ω.

4. A preparation method for low-temperature co-fired microwave dielectric ceramic material, comprising:
(a) Wet-mixing the ceramic material with a glass material of Li2O—BaO—SrO—CaO—B2O3-SiO2 at room temperature, wherein the ceramic material is composed of an eutectic phase composite and an additive, in which the eutectic phase composite is composed of a Mg2SiO4 powder and a Ca2SiO4 powder, the additive is composed of a CaZrO3 powder and a CaTiO3 powder; and
(b) Sintering the mixed material at a temperature of 900-970° C. for 0.5-4 hours.

5. A preparation method for low-temperature co-fired microwave dielectric ceramic material comprising:
(c) Wet-mixing the ceramic material with a glass material of Li2O—BaO—SrO—CaO—B2O3-SiO2 at room temperature, wherein the ceramic material is composed of an eutectic phase composite and an additive, in which the eutectic phase composite is composed of a Mg2SiO4 powder and a Ca2SiO4 powder, the additive is composed of a CaZrO3 powder and a CaTiO3 powder; and
(d) Sintering the mixed material with a Ag or Cu electrode at a temperature of 900-970° C. for 0.5-4 hours.

6. The preparation method for low-temperature co-fired microwave dielectric ceramic material according to claim 4 or 5, wherein the Mg2SiO4 powder is obtained by calcining MgO and SiO2 at 900-1300° C. for 4-10 hours and then grinding for refinement; the Ca2SiO4 powder is obtained by calcining CaO and SiO2 at 900-1200° C. for 4-10 hours and then grinding for refinement; the CaTiO3 powder is obtained by calcining CaO and TiO2 at 900-1200° C. for 4-10 hours and then grinding for refinement; the CaZrO3 powder is obtained by calcining CaO and ZrO2 at 900-1200° C. for 4-10 hours and then grinding for refinement.

7. The preparation method for low-temperature co-fired microwave dielectric ceramic material according to claim 4, wherein the glass material of Li2O—BaO—SrO—CaO—B2O3-SiO2 is composed of a composition including 0-10 wt % Li2O powder, 1-10 wt % BaO powder, 1-10 wt % SrO powder, 5-20 wt % CaO powder, 5-30 wt % B2O3 powder and 10-50 wt % SiO2 powder, all of these powder forming wherein the composition forms the glass material of Li2O—BaO—SrO—CaO—B2O3-SiO2 after being melted at 1000-1300° C. for 2-10 hours and then being ground for refinement.

8. The preparation method for low-temperature co-fired microwave dielectric ceramic material according to claim 5, wherein the Mg2SiO4 powder is obtained by calcining MgO and SiO2 at 900-1300° C. for 4-10 hours and then grinding for refinement; the Ca2SiO4 powder is obtained by calcining CaO and SiO2 at 900-1200° C. for 4-10 hours and then grinding for refinement; the CaTiO3 powder is obtained by calcining CaO and TiO2 at 900-1200° C. for 4-10 hours and then grinding for refinement; the CaZrO3 powder is obtained by calcining CaO and ZrO2 at 900-1200° C. for 4-10 hours and then grinding for refinement.

9. The preparation method for low-temperature co-fired microwave dielectric ceramic material according to claim 5, wherein the glass material of Li2O—BaO—SrO—CaO—B2O3-SiO2 is a composition including 0-10 wt %, Li2O powder, 1-10 wt % BaO powder, 1-10 wt % SrO powder, 5-20 wt % CaO powder, 5-30 wt % B2O3 powder and 10-50 wt % SiO2 powder, wherein the composition forms the glass material of Li2O—BaO—SrO—CaO—B2O3-SiO2 after being melted at 1000-1300° C. for 2-10 hours and then being ground for refinement.
